(19) United States
(12) Patent Application Publication
(10) Pub. No.: US 2003/0229667 A1
(43) Pub. Date: Dec. 11, 2003

(54) System, computer product and method for delivering pictures electronically

(76) Inventors: Nils-Johan Pedersen, Oslo (NO); Kjetil Hoem, Aas (NO); Christopher Richard Louis Blishen, London (GB)

Correspondence Address: MILLER THOMPSON, LLP, 20 QUEEN STREET WEST, SUITE 2500, TORONTO, ON, M5H 3S1, CA

(21) Appl. No.: 10/165,315

(22) Filed: Jun. 10, 2002

(51) Int. Cl. G06F 15/16

(52) U.S. Cl. 709/206

(57) ABSTRACT

A system, computer product and method for distributing digital images electronically is provided. A system is provided whereby a first computer includes a computer product that permits a user to select one or more digital images, resize such images to a bandwidth conserving size, and send such digital images to a remote web server and a remote client computer. The user of the remote client computer selects one or more of such digital images for distribution by the remote web server by indicating the electronic mail addresses of one or more recipients. The remote web server includes a server software product for resizing the digital images to a first bandwidth conserving image size, and a second bandwidth conserving image size. The remote web server publishes the digital images to the World Wide Web in the first bandwidth conserving image size. The server software product assembles an electronic mail to each of the recipients containing the selected digital images in the second bandwidth conserving image size whereby the electronic mail permits the recipients to access the digital images in the first bandwidth conserving size via the World Wide Web. The invention includes a related method. In one embodiment of the invention, the user of the first computer maintains control of the high resolution digital image, in another embodiment of the invention, the remote web server maintains control of the high resolution digital image.

### FIELD OF THE INVENTION

This invention relates in general to systems, computer products and methods for distributing pictures via an interconnected network of computers. This invention still further relates to a system, computer product and method for delivering digital images by electronic mail.

### BACKGROUND OF THE INVENTION

Sharing pictures such as photographs with friends, family and other individuals sharing a common interest is a popular activity.

Digital images have recently become more common in the field of photography. Numerous technologies are used to scan photographs developed by well-known film exposure technologies so as to produce digital images. These digital images are then stored to the memory of a computer.

Also, various known personal electronic handheld digital cameras are now commercially available. These digital cameras employ a digitizing optical device such as a charge-coupled device detector that through associated circuitry converts light rays into digital electronic signals thereby producing the image of a subject.

After a picture-taking session, a user of a digital camera generally connects the camera to a personal computer, or removes the removable storage device that contains stored images from the camera, and connects the removable storage device to the personal computer. The personal computer executes a program that can read the stored images, either from the camera or the removable storage device, and display the images on a display of the personal computer. Under software control, the personal computer can also send one or more images to a printer, store the images as files on the personal computer, and carry out other functions.

Numerous prior solutions are known for sharing these digital images with other individuals or entities. For example, OFOTO™ at www.ofoto.com and SHUTTERFLY™ at www.shutterfly.com are representative of the many services that allow users to upload digital images from their computer to a web site accessible from the Internet, thereby permitting these images to be shared with third parties. These prior art solutions therefore represent a “PULL” solution to the problem of sharing pictures with third parties, in that the third parties must first visit a web site in order to view the pictures.

There is a need for a solution whereby the pictures are pushed to the third parties in a manner that is simple to and easy to use.

It also should be understood that there are numerous barriers to individuals owning and operating a digital camera. These barriers include cost and barriers to adoption of a new technology when many individuals already have a photo exposure camera that they are comfortable using. Also, the use of digital cameras require a personal computer, and over time a relatively significant amount of memory to store digital images. Similarly, there are similar barriers inherent in purchasing a scanner that is suitable for scanning in photo exposure pictures to produce digital images.

Similarly, few individuals have means for printing or reprinting images themselves, particularly to the measure of commercial quality, whether based on photo exposure images or digital images, and therefore do not effectively have their own means for distributing print or reprints to friends and family. Yet the use of digital images for the purpose of allowing third parties to decide whether or not they wish to have print or reprints of specific pictures is very convenient indeed as it permits distribution of the picture via electronic mail which is an inexpensive and rapid form of communication available to many individuals and businesses.

In view of the above, there is a need for a system, computer product and method for distributing pictures to third parties that permits the use of third party photofinishers for producing print or reprints. There is also a need for a system, computer product and method that permits a third party, as a further step, to produce the digital images to be distributed from photo exposure pictures.

### SUMMARY OF THE INVENTION

One object of the present invention is to provide a system, computer product and method for distributing digital images to third parties.

Another object of the present invention is to provide a system, computer product and method for distributing digital images to third parties, permitting third parties to select a subset of such digital images and order reprints of such subset of digital images.

One aspect of the present invention provides a system for distributing images between a first computer and at least one other remote computer via a server computer, said first computer, remote computer and server computer being connected to the Internet, said system comprising a first computer comprising an electronic mail means for data communication between said first computer and server computer, a digital image selection means at said first computer for selecting digital images from a memory associated with said first computer, a means for selecting an electronic mail address associated with said at least one other remote computer, a resizing means to resize said digital images, wherein said electronic mail means is adapted to create and send an electronic mail comprising said digital images to said server computer; and a server computer comprising an electronic mail means adapted to send and receive electronic mail from and to said first computer and said remote computer, a database for storing said digital images, a server digital image resizing means adapted to resize said digital images to a first bandwidth conserving image size, and a second bandwidth conserving image size, a web publishing means adapted to publish digital images in said first bandwidth conserving image size to the World Wide Web, an electronic mail assembling means adapted to assemble said digital images in said second bandwidth conserving image size into an image distribution electronic mail to be sent to said at least one remote computer, said image distribution electronic mail providing means at said at least one remote computer for accessing said digital images in said first bandwidth conserving size.

A further aspect of the present invention provides a web based print ordering system comprising a first computer comprising an electronic mail means for data communication between said first computer and a server computer, wherein said first computer and server computer are connected to the Internet, a digital image selection means at said first computer for selecting digital images from a memory associated with said first computer, a means for selecting an electronic mail address associated with at least one remote computer wherein said electronic mail means is adapted to create and send an electronic mail comprising said digital images to said server computer, the server computer comprises an electronic mail means adapted to send and receive electronic mail from and to said first computer and said remote computer, a database for storing said digital images, a server digital image resizing means adapted to resize said digital images to a first bandwidth conserving image size, and a second bandwidth conserving image size, a web publishing means adapted to publish digital images in said first bandwidth conserving image size to the World Wide Web, an electronic mail assembling means adapted to assemble said digital images in said second bandwidth conserving image size into an image distribution electronic mail destined for said at least one remote computer, said image distribution electronic mail comprising means for accessing said digital images in said first bandwidth conserving size, means for ordering prints of said digital images from at least one service provider.

One still further aspect of the present invention provides a computer product for distributing images between a first computer and at least one other remote computer via a server computer, said first computer, remote computer and server computer being connected to the Internet, said computer product comprising an electronic mail means for data communication between said first computer and server computer, a digital image selection means at said first computer for selecting digital images from a memory associated with said first computer, a means for selecting an electronic mail address associated with said at least one remote computer wherein said electronic mail means is adapted to create and send an electronic mail comprising said digital images to said server computer, wherein said server computer comprises an electronic mail means adapted to send and receive electronic mail from and to said first computer and said remote computer, a database for storing said digital images, a server digital image resizing means adapted to resize said digital images to a first bandwidth conserving image size, and a second bandwidth conserving image size, a web publishing means adapted to publish digital images in said first bandwidth conserving image size to the World Wide Web, an electronic mail assembling means adapted to assemble said digital images in said second bandwidth conserving image size into an image distribution electronic mail destined for said at least one remote computer, said image distribution electronic mail comprising means for accessing said digital images in said first bandwidth conserving size, wherein said computer product cooperates with said server computer to deliver said digital images in said second bandwidth conserving size to said at least one remote computer, and permit access to said digital images in said first bandwidth conserving size via said server computer.

A still further aspect of the present invention provides a method of distributing digital images comprising the steps of selecting at least one digital image from a memory associated with a first computer, selecting an electronic mail address associated with at least one remote computer creating a first electronic mail including said at least one digital image and sending said electronic mail to a server computer, resizing said at least one digital image at said server computer to a first bandwidth conserving image size and a second bandwidth conserving image size, publishing said at least one digital image in said first bandwidth conserving image size to the World Wide Web, creating a second electronic mail including said at least one digital image in said second bandwidth conserving image size, wherein the second electronic mail comprises means for accessing said at least one digital image in said first bandwidth conserving size from said server computer, sending the second electronic mail to said at least one remote computer.

One of the advantages of the present invention is that it permits distribution of digital images in a manner that saves bandwidth. Another advantage of the present invention is that it provides a simple and effective means for “pushing” digital images as well as the capacity to order reprints of such digital images to third parties in a manner that is simple and cost effective. A still further advantage of the present invention is that it permits the distribution of digital images from computer devices such as personal digital assistants and cell phones. A still further advantage of the present invention is that it permits the use of digital image distribution as a marketing tool for a range of products and services. Yet another advantage of the present invention is that it provides an easy method for selection of service providers associated with the image distribution process.

### BRIEF DESCRIPTION OF THE DRAWINGS

A detailed description of the preferred embodiment(s) is(are) provided herein below by way of example only and with reference to the following drawings, in which:

FIG. 1 is a system flowchart illustrating the constituent parts of one embodiment of the system of the present invention.

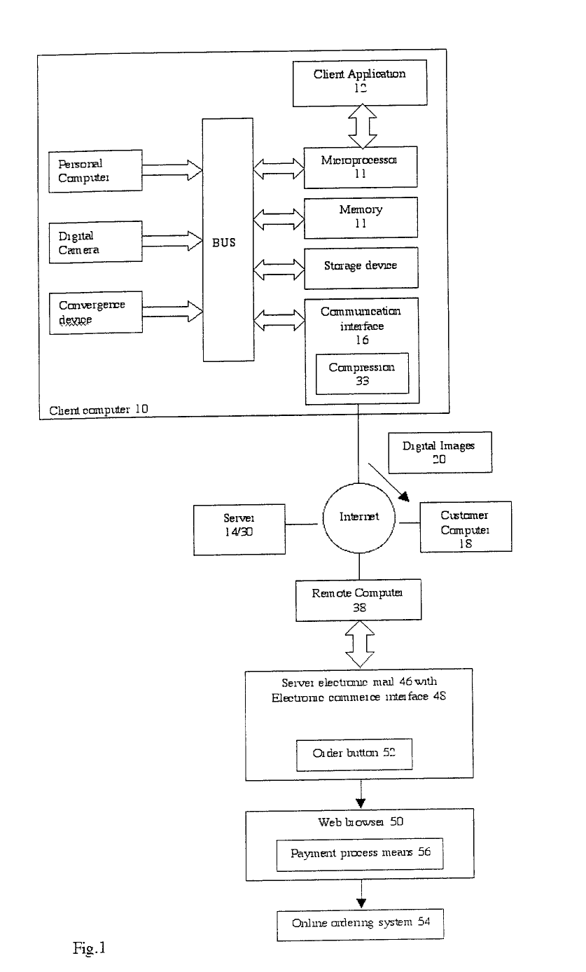

FIG. 2 is a software resource flowchart illustrating the resources of one embodiment of the software product of the present invention.

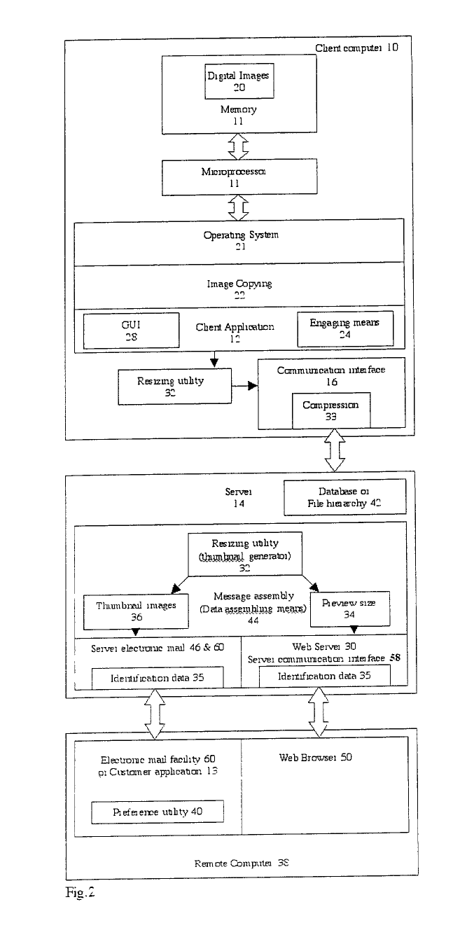

In the drawings, preferred embodiments of the invention are illustrated by way of example. It is to be expressly understood that the description and drawings are only for the purpose of illustration and as an aid to understanding, and are not intended as a definition of the limits of the invention

### DETAILED DESCRIPTION OF THE PREFERRED EMBODIMENT

The system of the present invention comprises known client computer 10 having a microprocessor and a memory 11. Computer 10 may comprise a number of known computer devices such as personal computers, digital television devices, WAP devices and the like. It should also be understood, that client computer 10 may comprise simply a digital camera that comprises a communication interface for connecting to the Internet permitting the digital images to be transferred to the web server described below. This particular aspect of the present invention is discussed further below.

In either case, the client computer 10 is connected to the Internet in a manner that is known.

The computer product of the present invention is best understood as a client application 12 on the first hand, and a server application 14 on the second hand.

Client application 12 is installed on a client computer 10 in a manner that is known. Client application comprises a data communication facility 16 such that client application 12 is adapted to communicate images to one or more computers remote from the client computer 10 via the Internet. The data communication facility 16 of the client application 12 is a known facility for transferring data, including digital images 20, to remote computers.

In a particular embodiment thereof, data communication facility 16 interfaces with repositories of email addresses at computer 10, including for example email address lists created by electronic mail utilities or customer relationship management (CRM) tools, resident on computer 10, in a matter that is also known. Alternatively, email addresses can be simply manually entered.

It should be understood that of the various embodiments of the present invention, a first embodiment and second embodiment are discussed in particular.

In a first embodiment of the present invention, a customer provides film exposure pictures, or the film itself, to a photofinisher. The customer is a user of a customer computer 18. The pictures are scanned by the photofinisher to produce the digital images 20. In this particular embodiment of the present invention, the photofinisher obtains client application 12, and loads same to computer 10.

In the second embodiment of the present invention, the user who originates the pictures has access to the digital images 20. This is either because the user has a scanner or a digital camera. This user in accordance with the second embodiment of the present invention controls client computer 10. In this second embodiment, client application 12 is loaded on this client computer 10. The digital images 20 in full resolution format are saved to a memory 11 associated with the client computer 10 in a manner that is well known. For example, digital images 20 are taken using a known digital camera and copied to the memory associated with the client computer 10. Alternatively, pictures including exposed and developed 35 mm or IX240 (APS) full rolls or any other film format are scanned and saved in memory of client computer 10 using a known scanning device and associated software.

The client application 12 of the present invention is adapted to send digital images 20 from the client computer 10 to remote computers, as well as distribute prints of these digital images to the users of such remote computers, as described below.

Client application 12 interfaces with an operating system 21 associated with the client computer 10 in a manner that is known. In particular embodiment thereof, the client application 12 provides an image copying means 22 that interfaces with the operating system 21 such that the digital images 20 are copied to the client application 12 by pulling and dragging digital images from a directory structure provided by the operating system 21. The directory structure shows the digital images, in a manner that is known.

Once the user of the client computer 10 has selected the digital images 20 to be sent to the remote computers, in accordance with the above, the data communication facility 16 of the client application 12 of the present invention is engaged. The engagement of the client application 12 permits the user of the client computer 10 to input, or access from an electronic mail address list, the electronic mail addresses associated with the desired remote computers. It is also contemplated by the present invention that the client application 12 in some cases forwards the digital images automatically to certain computer addresses or electronic mail addresses, such as the computer addresses or electronic mail addresses associated with the web server 30 described below, or approved sellers of goods or services (e.g. a photofinisher), as also explained below.

In a particular embodiment of the present invention, however, it should be understood that the present invention contemplates that data communication facility 16 includes a known FTP transfer facility for uploading files, including the digital images 20, to web server 30.

The client application 12 also provides an engaging means 24 for engaging the client application 12 to perform the processes described below, once all of the digital images 20 have been selected for transfer in accordance with the present invention. Specifically, the engaging means 24 is adapted to engage the data communication assembling means 26 described below. This engaging means 24 may include a “SEND” function associated with the graphical user interface 28 associated with the client application 12. The engaging means 24 permits the user of the client application 12 to indicate that the data communication assembled in accordance with the method described below is ready to be sent by means of the data communication facility 16 thereof to the remote computers referenced below.

A “CANCEL” function is further provided by the graphical user interface 28 which can be engaged by the user of the client application 12 in the event that the user wishes to cancel the communication of a particular data communication including digital images 20, in accordance with the present invention.

The data communication assembling means 26 executes a number of functions directed at distributing the digital images 20 in accordance with the method of the present invention.

The data communication assembling means 26 of present invention in turn includes a known resizing utility 32 that is adapted to resize the digital images 20 in accordance with predetermined parameters. The purpose of the resizing process is to distribute digital images 20 in accordance with the method of the present invention while economizing on bandwidth and server memory.

In accordance with the first preferred embodiment, the resizing utility 32 resizes the selected digital images to a preferred first bandwidth conserving image size or preview size. The preview size 34 in accordance with the present invention is preferably approximately 600 pixels. In accordance with the first preferred embodiment, previews 34 are sent to the web server 30, and digital images 20 in a second bandwidth conserving image size or thumbnails are generated on the web server 30 from the previews 34, as explained below.

It should be noted, however, that in a second embodiment of the invention, wherein the digital images 20 exist in high resolution format only on client computer 10, the digital images are sent in high resolution format to the web server 30. However, resizing utility 32 is still provided to the client application 12 of the second embodiment in order to resize digital images 20 that while being of high resolution quality are unnecessarily large for the purposes of the present invention, including making reprints. In accordance with this particular aspect of the present invention, resizing utility 32 is provided with specific parameters defining an image size that is considered too large, and where a digital image 20 is selected by the user of client application 12 for communication to web server 30, the image will be resized to a similarly defined maximum size. In the second embodiment of the present invention therefore, resizing utility 32 conserves bandwidth and memory at web server 30.

In accordance with either the first or second embodiment of the present invention, client application 12 may further include a compression utility 33 that compresses the digital images 20 in their full resolution format prior to dispatch by data communication facility 16 to web server 30. Web server 30 comprises a corresponding compression utility 33 that decompresses the digital images 20.

In accordance with both preferred embodiments, the digital images 20 selected by the user of client computer 10 are assembled by the data communication assembling means 26 into a data communication that is automatically sent to the location of web server 30 (further described below), wherein the web server 30 is connected to the Internet. In a particular embodiment of the present invention, the location of web server 30 is provided to memory (not shown) associated with the client application 12.

The data communication sent by the client application 12 in accordance with either first or second embodiment of the present invention includes identification data 35 that identifies the user of client computer 10, including its preferences, to web server 30. What is included in identification data is explained below.

The present invention contemplates that the web server 30 is utilized to distribute pictures to the users of remote computers utilizing the services of more than one seller services, including for example photofinisher services. It will also be understood from this disclosure, that the present invention presents means for significant cross-selling, promotional and marketing activities. Accordingly, the eventual delivery of electronic mail messages bearing image attachments in accordance with the present invention may be accompanied by references to various promotions potentially involving third parties. In accordance with the present invention, it is contemplated that the identity of such sellers of good or services is preferably provided by the data communication sent from the client computer 10 to the web server 30. This information is simply embedded in the data communication in a manner that is known to form part of identification data 35.

It should be understood that the user of the client application 12 may in some cases be an individual or business that wishes to distribute pictures to friends, family or business contacts. Such user may download the client application 12 from the operator of the web server 30. In this case, the operator of the web server 30 may determine which sellers of goods or services will be associated with the particular version of the client application 12 made available to the particular individual or business. Alternatively, the operator of web server 30 may provide the user of client application 12 with an option to choose among sellers of goods or services which choice is then passed on to the users of the remote computers (as explained below). The users of the remote computer, may in accordance with the present invention, themselves be given a choice between various sellers of goods or services.

In this way, it should be understood that the present invention, including the client application 12 may be used in the context of promotions, such that particular versions identifying, for example, particular sellers of goods or services, are made available for download at web server 30 in accordance with the parameters of a particular promotion, e.g. incentives, promotion specific web pages associated with the web server 30 and so on.

For the sake of clarity, it should be understood that the operator of web server 30 may also determine whether the user of the client application 12 will be permitted a choice as to which sellers of goods or services, including which competing photofinishers are associated with the electronic mail sent to the remote computers 38.

However, in the specific case of the first embodiment of the present invention, it should be understood that the user of client application 12 is a photofinisher. Also, as explained below, one of the users of a remote computer who receives an electronic mail in accordance with the present invention, is the entity who originated the pictures that are distributed in accordance with the present invention, or the customer. Understandably, in accordance with this first embodiment of the present invention, the photofinisher may not wish the customer to have a choice in different sellers of photofinishing services to be engaged by further recipients selected by the customer, such that the customer and the further recipients may engage the photofinisher who is the user of client application 12 or one of its affiliates.

It should also be understood that, in the case of the first embodiment, the present invention also includes a customer application 13 that is resident on customer computer. 18. The customer application 13 is adapted to receive an electronic mail from web server 30 that includes the thumbnail 36 images, and to receive commands from the user of customer computer 18 in regard to the email addresses of remote computer to which the thumbnail images are to be sent in accordance with the present invention. As particularized above in relation to the client application 12, these email addresses are input or are obtained from another software utility including email addresses loaded on customer computer 18.

In a particular embodiment of the present invention, the client application 12 (in the case of the second embodiment) or both the client application 12 and customer application 13 includes preferences utility 40. Preferences utility 40 permits the user of the client application 12 or the customer application 13 to set preferences regarding the particular sellers of goods or services associated with the electronic mail sent to the customer or to recipients designated by the customer, in accordance with the present invention. This may be done from a “POP DOWN” menu, in a manner that is well known. Alternatively, the preferences utility 40 is adapted to be set by the user of the client application 12 such that the menu of seller options referred to is presented to each recipient or customer (in the case of the first embodiment) upon delivery of thumbnails 36 to such recipient or customer.

The data communication including the preview pictures 34 (in the case of the first preferred embodiment) is communicated to the web server 30 in a manner that is well known. In the second preferred embodiment of the present invention, as indicated above, the digital images are sent to the web server 30 in a full resolution format (albeit possibly resized as indicated above), for distribution by the web server 30 to the photofinishers selected in accordance with the method described herein.

Web server 30 comprises a database or file hierarchy 40, provided in a manner that is well known. The preview pictures 34 (first embodiment) or digital images 20 in high resolution format (second embodiment) are stored to the web server 30 in a manner that is known.

The web server also includes a resizing utility 32. In the case of the second embodiment, the digital images 20 communicated to the web server 30 are decompressed by compression utility, and then these images are resized to provide preview pictures 34.

In the case of either of the first or second embodiment, the web server 30 publishes the preview pictures 34 automatically to the Internet in a manner that is known. In a particular embodiment of the present invention, the preview pictures 34 are published to a specific location associated within a file hierarchy 42 linked to the web server 30, that is accessible via the Internet.

The resizing utility 32 resizes the preview pictures 34 in accordance with predetermined parameters described below. In the case of the second embodiment, it may be the digital images in full resolution format or the preview pictures 34 that are resized. The purpose of this particular resizing process is to distribute thumbnails of the digital images 20 in accordance with the method of the present invention while economizing on bandwidth. The resizing utility 32 resizes the selected digital images to a preferred thumbnail size 36 of approximately 140 pixels.

The web server 30 comprises a server message assembling means 44. The server message assembling means 44 is adapted to assemble an electronic mail 46 for delivery to the recipient or recipients identified by the user of the client application 12. As is explained above, in the case of the first embodiment, the recipient will initially be the customer.

The server electronic mail 46 includes the thumbnail versions 36 of the pictures. These are automatically sized to permit viewing by the recipients. The electronic mail 46 also includes instructions for accessing the preview versions 34 of the digital images 20 from the web server 30. Specifically, in a particular embodiment of the present invention, accessing the preview versions 34 of the pictures requires the recipient to click on the thumbnail version 36 of a particular picture. The server message assembling means 44 is adapted to obtain the location of a particular preview version 34 corresponding to the particular thumbnail version thereof 36 on the database or file hierarchy 42, and provide the related link to the recipient by associating this link with the corresponding thumbnail 36 picture, in a matter that is known. Specifically, in this particular embodiment of the present invention, this link is embedded in the server electronic mail 46, such that the thumbnail 36 is superimposed over the link. In this manner, the web server 30 is adapted to permit the recipients to access the preview version 34 of the pictures via the Internet.

The server message assembling means 44 is also adapted to include in the server electronic mail 46 means for accessing offerings of predetermined goods and services of third parties via the Internet. This is achieved by including in the electronic mail an electronic commerce interface 48 for processing orders for such goods and services.

In one particular embodiment of the present invention, the electronic commerce interface 48 provides means for the recipients to make orders for such goods or services by processing instructions provided in the electronic mail 46 at the computers associated with the recipients.

Specifically, in one embodiment of the present invention, the electronic commerce interface 48 provides means for ordering reprints of the pictures included in the electronic mail. In this way, the present invention provides a web based print ordering system. Specifically, in this particular embodiment, at least one source of print production and delivery services is associated with the electronic mail 46. Means are provided in the electronic mail for selecting the particular goods or services that one or more of the recipients wishes to order from the print production and delivery services provider. Specifically, in this embodiment of the present invention, the electronic mail 46, in association with a known browser 50 in a manner that is known, permits the recipients to select the size of the reprint and other relevant information from one or more scroll down menus or text fields associated with each thumbnail version 36 of the images. The electronic mail 46 also provides means for sending the order to the print production and delivery service provider referenced in the electronic mail 46 (as explained above) by means of an “ORDER” 52 button or the like.

In the first embodiment of the present invention, electronic mail 46, as described above, enables the customer to view the thumbnails 36 of the digital images, and the preview 34 also, as described above. Based on this viewing, the customer may order reprints of these pictures, from the photofinisher using the client application 12, or one of his/her affiliates. The electronic mail 46 also permits the customer to select the electronic mail addresses of further recipients to whom the customer wishes an electronic mail 46 to be sent, such that the further recipients may also view the thumbnails 36, previews 34, and order reprints or order other goods or services in accordance with the present invention. It should be understood that the present invention contemplates restricting access to the web server 30 to permitted users only, for example, customers of photofinishers who have a relationship with the operator of web server 30, or in accordance with the second embodiment users who have registered with the operator of the web server 30, or in accordance with either the first or second embodiment, further recipients who are known by the web server 30 to be associated either with a known client or customer.

The present invention therefore facilitates the delivery of the order to the print production and delivery service provider. This is accomplished by web server 30 forwarding orders to the various service providers, including photofinishers, where an order has been placed by the recipient of an electronic mail 46 of the present invention.

For example, in the case of the first embodiment, when an order is placed by a recipient, including the customer, an order is sent in the form of an electronic mail that includes the text about the order (number of prints, identification of the image, and so on). In a particular implementation of this first embodiment, it is contemplated that a computer program is provides that reads the text of the electronic mail that includes the order, and feeds the information to a printer to automate the reprint process.

In another particular implementation of the first embodiment of the present invention where reprinting, for example, by permitted affiliates of the user of client application 12 is supported, the electronic mail including the order may be sent to one or more of such permitted affiliates, where the text of the order will include the name, telephone number, email address and location of the photofinisher associated with the client application 12, because the permitted affiliate(s) will have to obtain the high resolution digital image 12 from the original photofinisher. As is obvious, this would generally involve the compression and decompression of the digital images 20 as between the photofinisher and his/her affiliate. This particular implementation of this embodiment may be useful where the further recipients are geographically remote from the customer and/or photofinisher.

In regard to the second embodiment, the various photofinishers known to the web server 30 will obtain the high resolution digital image 12 from the web server 30, in a manner that is known, and again perhaps involving compression and decompression of the digital images 12.

The present invention also contemplates a known online ordering system 54 system and associated payment processing means 56. This online ordering system 54 is either provided by the web server 30, or by the production and delivery service provider. All that is required in either case is to route the electronic mail message initiated by the “ORDER” 52 button or equivalent in association with a browser 50 to the web server 30 or some other computer accessible via the Internet. In either case, the order is delivered to the appropriate seller of goods or services such as a photofinisher, and the recipient's account is debited or invoiced by the amount owed.

The present invention encompasses the use of various means of online payment such as Internet based account debiting methods, credit card processing systems, digital cash applications and so on.

It should be understood, that the present invention may be associated with other sellers of goods and services by simply providing the particulars for accessing one or more other online ordering systems 54 in accordance with the method of the invention. The identity of the sellers of goods and services to be associated with the specific electronic mail is ultimately determined by the server message assembling means 44, including perhaps in co-operation with the preferences utility 40, as explained above. The server message assembling means 44 provides means for leveraging the present invention to run multiple promotions for multiple clients, in accordance with processes provided to the message assembling means 44 in a manner that is known. The server message assembling means 44 is also responsive to the identity of the sellers of goods and services either associated with the electronic mail received from the user of the client computer 10 based on the selection of sellers of goods or services by this user or the sellers of goods or services associated with the electronic mail from the client computer 10 by the client application 12 without any possibility of selection by the user of the client computer, as described above.

In the preferred embodiment of the present invention, the selection of particular sellers of goods or services may depend on the geographic location of the particular recipient. This is because the delivery of particular goods or services in accordance with the present invention may be facilitated by tailoring the electronic mail received by the recipients such that the sellers of goods or services incorporated in the electronic mail are geographically proximate to the recipient. This may be achieved by the user of the client application 12 selecting a seller of goods or services in the vicinity of each recipient using a “POP DOWN” menu, for example, in a manner that is known. Alternatively, the user of the first computer product can select the geographic location of the recipients, which information is then communicated by the electronic mail sent to the web server 30, in accordance with the present invention. Web server 30, in turn, is adapted by means of server message assembling means 44 to associate information regarding sellers of goods or services located in the vicinity of each individual recipient by accessing this information from database 42.

It should be understood that server message assembling means 44 in cooperation with the database 42 provides means for associating specific data with specific electronic mail, for example, data specific to particular sellers of goods or services. The data comprises instructions for purchasing goods or services such as photofinishing services, marketing text or images and so on. It should be understood, that in this manner the present invention comprises a marketing and promotions system, which given the popularity of messages has aspects of what is commonly referred to as “viral marketing”.

The web server 30 is a known server computer connected to the Internet comprising a server communication interface 58 that is adapted to facilitate sending and receiving of messages via the Internet. The web server further comprises a server computer product 14 that executes the functions of the present invention. The server computer product 14 comprises a server electronic mail facility 60 for sending, receiving and processing electronic mail messages in accordance with the present invention.

It should be understood that in another embodiment of the present invention, the web server 30 is provided with the digital images 20 themselves, which are resized by the server application 14 rather than the client application 12.

It should be understood that it is contemplated that the first computer product will be associated with known photo kiosks, wherein such photo kiosks are connected to the web server 30 of the present invention via the Internet.

It should also be understood that the first computer may comprise any form of computer that supports communication over the Internet, including for example WAP devices as stated earlier. In this way, the present invention provides means for delivering pictures to recipients to their WAP-enabled cell phones, RIM two-way pagers and the like, as well as ordering goods and services, including print or reprints using these devices.

Also as stated earlier, the first computer may comprise a digital camera that is adapted to be connected to the Internet. The present invention when used with a digital camera in this manner provides the additional benefit of being able to view digital images taken with the digital camera, as well as distributing these images to third parties. Viewing the digital images produced by a digital camera generally requires a personal computer. However, in another preferred embodiment of the present invention, the client application 12 of the present invention is provided to a computer associated with the digital camera and in accordance with the method of the present invention these images are sent to the web server 30. Further, in accordance with the present invention, the thumbnail version 36 can be sent to the recipients, one of whom may be the user of the digital camera itself. In accordance with this particular embodiment of the present invention, this permits the user of the digital camera to view and select images for photofinishing, for example, without the need for a personal computer.

In an example of the present invention in operation, school photographers could use the present invention for distribution of prepared pictures. The school photographer could send the images to the school, which in turn using the computer product of the present invention would send the images to the parents' electronic mail database in accordance with the present invention. The web server 30 would then process order for the images selected by the various parents.

In another example of the present invention in operation, the present invention is used to deliver pictures and advertising regarding promotional items related to a sport franchise, for example, to the fan electronic mail database. This permits reprinting of sport photos, distribution of t-shirts and other promotional items.

It should be understood that the client application 12 of the present invention can be associated with a known program used to scan images. This allows the user of such program to send digital images electronically in accordance with the present invention once such images are scanned using the scanning program. Alternatively, the present invention can be associated in a manner that is known with programs for management and processing of digital images such as PHOTOSHOP™ or PHOTOIT™. The functionality disclosed in the present invention is in this case associated with a “SEND” function or equivalent, for example, within the user interface of such known programs.

It should also be understood that the user of the client application 12 may actually be a photofinisher. The photofinisher may develop the photo exposure pictures of an individual or business. This individual or business may engage the photofinisher to digitize its pictures and distribute it electronically to third parties in accordance with the present invention. The electronic mail addresses can be provided by the individual or business to the photofinisher in accordance with a number of known methods, including electronically in association with an electronic mail list organizer. Alternatively, the digital image recording medium associated with the digital camera can be provided to the photofinisher or similar seller of goods or services for distribution of the digital images and ordering of prints or reprints in accordance with the present invention.

In another aspect of the present invention the client computer 10 is a wireless computer device, and the web server 30 further comprises known means for detecting the approximate geographic location of the wireless computer device, wherein the present invention permits the user of the wireless computer device to obtain the prints or reprints from an approved photofinisher that is relatively proximate geographically to the geographic location of the wireless computer device.

Other variations are possible without departing from the spirit of this invention. For example, the client application 12 of the present invention can be associated with known update utilities for accessing software updates from the web server 30 via the Internet. These utilities may comprise software upgrades to the functions of the client computer product, advertising or information regarding new promotions being offered in association with the web server 30.

We claim:

1) A system for distributing images between a first computer and at least one other remote computer via a server computer, said first computer, remote computer and server computer being connected to the Internet, said system comprising:
a) A first computer comprising:
i) an electronic mail means for data communication between said first computer and server computer;
ii) a digital image selection means at said first computer for selecting digital images from a memory associated with said first computer;
iii) a means for selecting an electronic mail address associated with said at least one other remote computer;
iv) a resizing means to resize said digital images;
wherein said electronic mail means is adapted to create and send an electronic mail comprising said digital images to said server computer; and
b) A server computer comprising:
i) An electronic mail means adapted to send and receive electronic mail from and to said first computer and said remote computer;
ii) A database for storing said digital images;
iii) A server digital image resizing means adapted to resize said digital images to a first bandwidth conserving image size, and a second bandwidth conserving image size;
iv) A web publishing means adapted to publish digital images in said first bandwidth conserving image size to the World Wide Web;
v) An electronic mail assembling means adapted to assemble said digital images in said second bandwidth conserving image size into an image distribution electronic mail to be sent to said at least one remote computer, said image distribution electronic mail providing means at said at least one remote computer for accessing said digital images in said first bandwidth conserving size.

2) A system for distributing images as claimed in claim 1, wherein said image distribution electronic mail further comprises means for ordering products or services.

3) A system for distributing images as claimed in claim 2, wherein said image distribution electronic mail comprises means for ordering prints of said digital images from at least one service provider.

4) A system for distributing images as claimed in claim 3, wherein said server computer further comprises an electronic commerce means facilitating payment for products or services.

5) A system for distributing images as claimed in claim 4, wherein said electronic commerce means facilitates payment for said prints of said digital images.

6) A system for distributing images as claimed in claim 5, wherein said at least one service provider or seller of products is selected by the operator of the server computer.

7) A system as claimed in claim 5, wherein said at least one service provider or seller of products is selected by the user of the first computer from a list of service providers or sellers of products provided by the operator of the server computer.

8) A system as claimed in claims 6 or 7, wherein said server computer further comprises means for transmitting orders for products or services received from the user of said at least one remote computer to said service providers or sellers of products.

9) A system as claimed in claim 8, wherein said first bandwidth conserving sized image is a preview image.

10) A system as claimed in claim 9, wherein said second bandwidth conserving sized image is a thumbnail.

11) A system as claimed in claim 10, wherein said means for accessing said digital images in said first bandwidth conserving image size comprises a web link embedded in said image distribution electronic mail, wherein in cooperation with a browser the user of the remote computer accesses said digital images in said first bandwidth conserving image size stored to said database at said server computer via the Internet.

12) A system as claimed in claim 3, wherein said image distribution electronic mail comprises means for ordering prints in a size selected by each user of the at least one remote computer.

13) A system as claimed in claim 11, wherein said image distribution electronic mail comprises means for selecting the service provider of the prints.

14) A system as claimed in claim 12, wherein said image distribution electronic mail comprises means for each user of the at least one remote computer to select a service provider of the prints based on the geographic location of the service provider of the prints.

15) A system as claimed in claim 13, wherein said at least one remote computer is a computer connected to a wireless network, and said server computer comprises means for determining the approximate geographic location of the at least one remote computer, such that said image distribution electronic mail is adapted to communicate to the user of the at least one remote computer the location of a service provider of the prints that is geographically proximal to said approximate geographic location of the user of the at least one remote computer.

16) A system as claimed in claims 1 to 14, wherein said digital image selections means comprises an operating system interface that is adapted to permit the user of the first computer to click and drag digital images to a graphical user interface.

17) A system as claimed in claim 15, wherein said electronic mail means of the first computer is adapted to send electronic mails automatically to the server computer by accessing an electronic mail address associated with the server computer from said memory associated with the first computer.

18) A system as claimed in claims 1 to 17, wherein user of said first computer is a service provider, including photofinishers, and wherein the user of said at least one remote computer is a client of said service provider.

19) A system as claimed in claim 18, wherein said system comprises a plurality of remote computers, including at least one client computer, and said client computer includes:
a) an electronic mail means for data communication between said client computer and said server computer;
b) a digital image selection means for selecting digital images received from said first computer for distribution; and
c) a means for selecting an electronic mail address associated with at least one other of said plurality of remote computers
whereby said client computer communicates to said server the identity of the digital images and electronic mail addresses of at least one other of said plurality of remote computers, for distribution of said selected digital images.

20) A web based print ordering system comprising:
a) A first computer comprising:
i) an electronic mail means for data communication between said first computer and a server computer, wherein said first computer and server computer are connected to the Internet;
ii) a digital image selection means at said first computer for selecting digital images from a memory associated with said first computer;
iii) a means for selecting an electronic mail address associated with at least one remote computer
wherein said electronic mail means is adapted to create and send an electronic mail comprising said digital images to said server computer;
b) the server computer comprises:
i) An electronic mail means adapted to send and receive electronic mail from and to said first computer and said remote computer;
ii) A database for storing said digital images;
iii) A server digital image resizing means adapted to resize said digital images to a first bandwidth conserving image size, and a second bandwidth conserving image size;
iv) A web publishing means adapted to publish digital images in said first bandwidth conserving image size to the World Wide Web;
v) An electronic mail assembling means adapted to assemble said digital images in said second bandwidth conserving image size into an image distribution electronic mail destined for said at least one remote computer, said image distribution electronic mail comprising:
(1) means for accessing said digital images in said first bandwidth conserving size;
(2) means for ordering prints of said digital images from at least one service provider.

21) A web based print ordering system as claimed in claim 20, wherein said image distribution electronic mail means further comprises an electronic commerce means facilitating payment for products or services.

22) A computer product for distributing images between a first computer and at least one other remote computer via a server computer, said first computer, remote computer and server computer being connected to the Internet, said computer product comprising:
a) an electronic mail means for data communication between said first computer and server computer;
b) a digital image selection means at said first computer for selecting digital images from a memory associated with said first computer;
c) a means for selecting an electronic mail address associated with said at least one remote computer
wherein said electronic mail means is adapted to create and send an electronic mail comprising said digital images to said server computer;
d) wherein said server computer comprises:
i) An electronic mail means adapted to send and receive electronic mail from and to said first computer and said remote computer;
ii) A database for storing said digital images;
iii) A server digital image resizing means adapted to resize said digital images to a first bandwidth conserving image size, and a second bandwidth conserving image size;
iv) A web publishing means adapted to publish digital images in said first bandwidth conserving image size to the World Wide Web;
v) An electronic mail assembling means adapted to assemble said digital images in said second bandwidth conserving image size into an image distribution electronic mail destined for said at least one remote computer, said image distribution electronic mail comprising means for accessing said digital images in said first bandwidth conserving size;
wherein said computer product cooperates with said server computer to deliver said digital images in said second bandwidth conserving size to said at least one remote computer, and permit access to said digital images in said first bandwidth conserving size via said server computer.

23) A computer product as claimed in claim 21, wherein said image distribution electronic mail means further comprises means for ordering prints of said digital images from at least one service provider, wherein said computer product and server computer cooperate to permit ordering of prints of said digital images at said at least one remote computer.

24) A method of distributing digital images comprising the steps of:
a) Selecting at least one digital image from a memory associated with a first computer;
b) Selecting an electronic mail address associated with at least one remote computer;
c) Creating a first electronic mail including said at least one digital image and sending said electronic mail to a server computer;
d) Resizing said at least one digital image at said server computer to a first bandwidth conserving image size and a second bandwidth conserving image size;
e) Publishing said at least one digital image in said first bandwidth conserving image size to the World Wide Web;
f) Creating a second electronic mail including said at least one digital image in said second bandwidth conserving image size, wherein the second electronic mail comprises means for accessing said at least one digital image in said first bandwidth conserving size from sad server computer;
g) Sending the second electronic mail to said at least one remote computer.
